(19) United States
(12) Patent Application Publication
(10) Pub. No.: US 2012/0137994 A1
(43) Pub. Date: Jun. 7, 2012

(54) ROLLERIZED CAMSHAFT SUPPORT FOR TYPE 1 DIRECT ACTING VALVETRAIN AND INTERNAL COMBUSTION ENGINE EMBODYING SAME

(75) Inventor: Nayan Engineer, Canton, MI (US)

(73) Assignees: HYUNDAI MOTOR COMPANY, Seoul (KR); KIA MOTORS CORPORATION, Seoul (KR); HYUNDAI AMERICA TECHNICAL CENTER, INC., Superior Township, MI (US)

(21) Appl. No.: 12/961,484

(22) Filed: Dec. 6, 2010

(51) Int. Cl. F01L 1/00; F16C 33/48

(52) U.S. Cl. 123/90.1; 384/572

(57) ABSTRACT

Featured is a rollerized camshaft support to rotatably support a camshaft of a Type I valvetrain, the camshaft having at least one rotating surface. Such a rollerized camshaft support includes at least one rollerized bearing and at least one bearing support for each of the rollerized bearings, where each bearing support includes a bearing upper support element and bearing lower support element. Each rollerized bearing includes an inner raceway; an outer raceway and a plurality of rolling elements disposed between the inner and outer raceways and extending widthwise across the raceways. The bearing upper support element and bearing lower support element are configured so as to receive there between a rollerized bearing. Also, the bearing lower support element is configured and arranged so to complement a portion of a configuration of the Type I valve train.

### FIELD OF INVENTION

The present invention generally relates to support structures for rotatably supporting a camshaft more particularly to a rolling bearing camshaft support structure and yet more particularly to such a rolling bearing support structure for an overhead camshaft configuration. In yet more particular arrangements, the present invention relates to a rolling bearing support structure for an overhead camshaft configuration having a type I direct acting valvetrain configuration as well as an internal combustion engine having such a support structure and type I direct acting valvetrain.

### BACKGROUND OF THE INVENTION

As is known to those skilled in the art, a reciprocating engine or internal combustion engine includes one or more camshafts, such as the exemplary camshaft 20 shown in FIG. 1A. The camshaft(s) separately linearly move the intake valve(s) and exhaust valve(s) respectfully of a valvetrain responsive to the rotary movement of the camshaft(s).

The camshaft 20 typically includes a shaft part 22 and a plurality of cams 24. The shaft part 22 is rotatably supported by one or more bearings and counterpart structure of the cylinder head of the engine. The camshaft 20 is connected to the crankshaft of the engine by a timing belt (not shown) or other structure (e.g., gears), such that the camshaft rotates according to the rotation of the crankshaft.

As each cam 24 is operably coupled or connected respectively to an intake valve or an exhaust valve, the same number of cams is provided as the number of valves. Each cam 24 includes a relatively long diameter part 24a, sometimes referred to as a lobe, and a relatively short diameter part 24b. The plurality of cams 24 are arranged along the camshaft 20 in such a way that the positions of the long diameter parts 24a are shifted in a circumferential direction. Thus, the intake and exhaust valves as they are operably connected to each of the plurality of cams 24, can be opened and closed at different timings responsive to rotation of the respective camshaft.

Such a reciprocating engine or internal combustion engine 10 is configurable so as to include one or more cylinders more particularly 4 cylinders, 6 cylinders, 8 cylinders, 10 cylinders and 12 cylinders. Also, the cylinders are arranged in the engine so as to be in a line, slanted, to form a V, or arranged in any of a number of ways as one known to those skilled in the art. Thus, the number of camshafts and the arrangement of the camshafts are dependent upon the number of cylinders and the arrangement of the cylinders.

As is known to those skilled in the art, a reciprocating or internal combustion engine can be arranged so as to have two camshafts in that are provided and arranged on the upper side of each cylinder head and so as to be on each side of the intake valve and the exhaust valve. Such an arrangement is typically referred to as a double over head cam or camshaft (DOHC) arrangement. In such a DOHC configuration, the cams of one camshaft are operably coupled to the intake valve(s) so as to respectively open and close each intake valve at the appropriate timing and the cams of the other camshaft are operably coupled to the exhaust valve(s) so as to respectively open and close each exhaust valve at the appropriate timing. Alternatively, and as is known to those skilled in the art, an internal combustion is configurable so there is one camshaft (i.e., a single overhead camshaft—SOHC) for each cylinder head that includes cams that are arranged along the camshaft so as to open and close each of the intake and exhaust valves at the appropriate timing. In the case where the internal combustion engine includes more than one cylinder head such as when the engine is in a V configuration, there are two sets of camshafts provided, one set for each cylinder head.

When the intake valve is described as being opened, the long diameter part 24a of the respective cam 24 abuts a respective end of the intake valve 30a. In this way, the intake valve is pushed downward against the force of the valve spring, thereby causing the intake valve head to be displaced from the valve seat and extend into the cylinder. When the intake valve is described as being closed, the short diameter part 24b of the cam 24 abuts the respective end of the intake valve so that the intake valve is pushed upward by the restoring force of the valve spring. This also applies for the exhaust valve and thus, its description will not be repeated here.

The most common technique or mechanism for rotatably supporting a camshaft 20 in an overhead camshaft engine configuration is an assembly that includes a plurality of thin film hydrodynamic bearings including complementary bearing support structure in the cylinder head, where the hydrodynamic bearings are in spaced relation along the length of the camshaft. More specifically, a bearing assembly is typically provided corresponding to each shaft part 22 of the camshaft. In such a bearing assembly, pressurized oil is introduced between the outside surface of each shaft part 22 and the opposing hydrodynamic bearing structure. Such a pressurized thin film of oil in combination with the other hydrodynamic bearing structure rotatably supports the camshaft and the oil also acts as a lubricant so as to thereby reduce friction as the camshaft rotates. At low engine speeds or when idling the engine, the oil pump does not generate enough pressure to form the pressurized thin film of oil; rather a mixed film is formed. As is known to those skilled in the art, this mixed film condition increases frictional forces as compared to the thin film condition, thereby leading to higher camshaft torques at such low speeds and when idling the engine.

This also is of concern when the engine is being started after it has been stopped for a while because there is likely to be little to no oil available for lubrication between the camshaft and the bearing support surfaces (e.g., no or little lubricant between the fixed structure of the cylinder head and the camshaft) when the engine is being started. In other words, it is likely that there will be metal to metal contact with the shaft part 22 of the camshaft when starting the engine thereby increasing wear on the bearing assembly.

In U.S. Patent Publication Nos. 2009/0235887 and US 2010/0012059, a roller type bearing is provided which in combination with structure in the cylinder head, rotatably supports the camshaft. The needle type bearing found in U.S. Patent Publication No. US 2009/0235887 is a roller type bearing including an outer ring formed by connecting a plurality of arc-shaped outer ring members in a circumferential direction, and a plurality of needle rollers arranged along the inner diameter surface of the outer ring, and an oil groove extending in a circumferential direction that is formed in the outer diameter surface of the outer ring member.

The roller bearing found in U.S. Patent Publication No. 2010/0012059 includes an outer ring formed by connecting a plurality of arc-shaped outer ring members in a circumferential direction and a plurality of rollers arranged along an inner diameter surface of the outer ring. A sloped surface is provided at one or each circumferential end on an inner diameter surface of the outer ring member, and a contour line of the slope surface is along a direction perpendicular to a revolution direction of the roller.

The roller bearing assembly described in both of these applications; (1) are intended for full width support of the outer ring member; (2) have a lubrication channel formed or machined in the upper bearing raceway that extends in a circumferential direction on and about the center of the upper bearing raceway; and (3) have a drawn cup outer raceway design to control bearing axial motion. As shown in FIG. 2B, in a Type I valvetrain, the machining of the surface pockets or buckets in the cylinder head to receive the bucket type tappets causes the lower bearing support structure in the cylinder head to have a significantly reduced width. Such a reduced width means that the lower bearing support structure will not provide support across the entire width of a full width bearing assembly such as found in the above-referenced patent application publications.

In addition, the lubrication channel formed or machined in the upper bearing raceway which extends in a circumferential direction on and about the center of the upper bearing raceway as described in these publications, also reduces the thickness of the raceway, in the region where the reduced width lower bearing support structure would be found in a Type I valvetrain. In addition, such a groove would mean that it is likely that there will be a gap between the raceway and the lower bearing support structure. Such a configuration would mean that there would be little or no contact between the raceway groove and the reduced width lower bearing support structure, particularly in the area of the groove which would be unacceptable.

Also, the drawn cup outer raceway design, which helps control bearing axial motion in these full width configurations, creates the potential for unacceptable interferences between moving structure of the valve train because of where the tappets and the related lobe(a) of the cam are located in a Type I valvetrain.

Moreover, while the needle rollers rotate about their center of rotation within the roller bearing, the roller bearing itself also rotates about the center of the camshaft. Thus, in a Type I valvetrain configuration, the roller bearing would rotate through the reduced width lower bearing support structure. At least because of the above-described difficulties a roller bearing such as that described in the above identified patent application publications, has not been used in an internal combustion engine having a Type I valvetrain configuration.

Also, the reduced width of the lower bearing support also is a further particular concern for the use of a hydrodynamic bearing when the valvetrain is a Type I valvetrain during start-up, idle and low engine speed operation (e.g., increases frictional forces).

It thus would be desirable to provide a bearing support structure for rotatably supporting a camshaft when using a Type I valvetrain, as well as method for rotatably supporting a camshaft when using a Type I valvetrain. It would be particularly desirable to provide such a device and method that would rotatably support the cam shaft when the bearing support structure embodies a roller type bearing element. It also would be desirable to provide such a roller type bearing support structure that does not significantly alter the size and configuration of the related parts as compared to prior art devices or structures.

### SUMMARY OF THE INVENTION

In broad aspects the present invention features a rollerized camshaft support to rotatably support a camshaft of a Type I valvetrain, the camshaft having at least one rotating surface. Such a rollerized camshaft support includes at least one rollerized bearing and at least one bearing support for each of the rollerized bearings, where each bearing support includes a bearing upper support element and bearing lower support element. Each rollerized bearing includes an inner raceway; an outer raceway and a plurality of rolling elements disposed between the inner and outer raceways and extending widthwise across the raceways. The bearing upper support element and bearing lower support element are configured so as to receive there between a rollerized bearing. Also, the bearing lower support element is configured and arranged so to complement a portion of a configuration of the Type I valve train.

According to one aspect of the present invention there is featured a rollerized camshaft support to rotatably support a camshaft used with a Type I valvetrain. Such a camshaft having at least one cam for each intake valve and exhaust valve and at least one rotating surface, where the cams and the at least one rotating surface being positioned along the length of the camshaft. Such a rollerized camshaft support includes at least one rollerized bearing and at least one bearing support for each of said at least one rollerized bearing. In further embodiments, the camshaft includes a plurality of cams and a plurality of rotating surfaces; and the rollerized camshaft support includes a plurality of rollerized bearings and a plurality of supports; one rollerized bearing and bearing support for each of said plurality of rotating surfaces.

Each of the at least one or plurality of rollerized bearing includes an inner raceway that extends circumferentially and axially about each of the at least one rotating surface, an outer raceway extending circumferentially and axially about the inner raceway; and a plurality of rolling elements disposed between the inner and outer raceways and extending widthwise across the raceways. Each of the at least one or plurality of bearing supports includes a bearing upper support element and bearing lower support element.

The bearing upper support element and bearing lower support element are configured so as to receive there between a rollerized bearing. The bearing lower support element is configured and arranged so to complement a portion of a configuration of the Type I valve train.

In more particular embodiments, the bearing upper support element has a first inner surface that opposes the inner raceway, the first inner surface having a first width and the bearing lower support element has a second inner surface that opposes the inner raceway, the second inner surface having a second width. With such an arrangement the first width is larger than the second width and a width of the inner raceway is essentially unchanging.

In further embodiments, the widths of the first and second widths are such that a ratio of the second width to the first width is in the range of about 30% to about 50%. Also, the second width varies circumferentially so as to vary between a minimum width and a maximum width.

In yet further embodiments, the widths of the first and second widths satisfy one or more of the following relationships:

(a) the minimum width of the second width (W₂) divided (/) by the first width (W₁) is in the range of from about 30% to about 50% (i.e., about 30%≦W₂/W₁≦about 50%)

(b) is greater than or equal to about 30% (i.e., W₂/W₁≧about 30%); or

(c) the minimum width of said second width/first width is less than or equal to about 50% (i.e., W₂/W₁≦about 50%).

In yet further embodiments, each rollerized bearing further includes a cage that is configured so the plurality of rolling elements are maintained in spaced relation circumferential. Such a cage also is configured to include a plurality of tabs that extend perpendicular to a circumferential end surface of the cage so as to be proximal a circumferential end surface of one of the inner raceway or the outer raceway.

In yet further embodiments, the first inner surface of the bearing upper support element is configured with a channel that extends at least a part of the circumference of the inner surface, the channel being fluidly coupled to a source of lubricant and the inner raceway is configured so as to include a through aperture. In addition, the channel is further arranged so as to be fluidly coupled to the through aperture. In this way, the lubricant, such as pressurized oil, is communicated through the channel and thence through the through aperture so that the roller elements of the rollerized bearing are lubricated.

According to another aspect of the present invention there is featured an internal combustion engine having a Type I valvetrain, at least one intake valve and at least one exhaust valve. Such an internal combustion engine includes a camshaft having at least one cam for each intake valve and each exhaust valve and at least one rotating surface, where the cams and at least one rotating surface are positioned along the length of the camshaft, and a rollerized bearing support, one rollerized bearing support for each of the at least one rotating surface.

Each of the rollerized bearing support includes at least one rollerized bearing and at least one bearing support. Each rollerized bearing includes an inner raceway that extends circumferentially and axially about each of said at least one rotating surface, an outer raceway extending circumferentially and axially about the inner raceway; and a plurality of rolling elements disposed between the inner and outer raceways and extending widthwise across the raceways. Each rollerized bearing support includes a bearing upper support element and bearing lower support element. The bearing upper support element and bearing lower support element are configured so as to receive there between said at least one rollerized bearing. Also, the bearing lower support element is configured and arranged so to complement a portion of a configuration of the Type I valve train.

In further embodiments, the bearing upper support element has a first inner surface that opposes the inner raceway, the first inner surface having a first width and the bearing lower support element has a second inner surface that opposes the inner raceway, the second inner surface having a second width. In more particular embodiments, the first width is larger than the second width and a width of the inner raceway is essentially unchanging.

In further embodiments, the widths of the first width (W₁) and second width (W₂) satisfy the following relationship: about 30%≦W₂/W₁≦about 50%. In more particular embodiments, the second width varies circumferentially so as to vary between a minimum width and a maximum width.

In yet further embodiments, the widths of the first and second widths satisfy one of the following relationships:

(a) about 30%≦W₂/W₁≦about 50%;

(b) W₂/W₁≧about 30%; or

(c) W₂/W₁ about 50%.

In yet further embodiments, each rollerized bearing further includes a cage that is configured so the plurality of rolling elements are maintained in spaced relation circumferential and wherein the cage includes a plurality of tabs that extend perpendicular to a circumferential end surface of the cage so as to be proximal a circumferential end surface of one of the inner raceway or the outer raceway.

In yet further embodiments, the first inner surface of the bearing upper support element is configured with a channel that extends at least a part of the circumference of the inner surface, the channel being fluidly coupled to a source of lubricant and the inner raceway is configured so as to include a through aperture. In addition, the channel is further arranged so as to be fluidly coupled to the through aperture.

In yet further embodiments, the camshaft includes a plurality of rotating surfaces; and the rollerized camshaft support further includes a plurality of rollerized bearings and a plurality of bearing supports, one rollerized bearing an bearing support for each of said a plurality of rotating surfaces.

According to another aspect of the present invention there is featured, a method for rotatably supporting a camshaft for a Type I valvetrain, where the camshaft causes selective movement of each of the at least one intake valve and at least one exhaust valve of a reciprocating engine. Such a camshaft includes at least one rotating surface region. Such a methods includes providing at least one rollerized bearing support, where each rollerized bearing support includes a roller type bearing and a bearing support structure.

The roller type bearing includes an inner raceway, an outer raceway, and a plurality of rotating elements disposed there between and extending widthwise across the respective raceways. The bearing support structure includes a top support member and a bottom support member, where the bearing bottom support member is configured so as to complement a configuration of the Type I valvetrain.

The bearing upper support member and bearing lower support member are configured so as to receive there between the roller type bearing and so that the outer raceway thereof opposes an inner surface of both of the bearing upper support member and bearing lower support member.

Such a method includes locating a respective one of the at least one roller bearing about each of the at least one rotating surface region of the camshaft and rotatably securing the camshaft and the respective roller bearing between the bearing upper support member and bearing lower support member.

Other aspects and embodiments of the invention are discussed below.

### DEFINITIONS

The instant invention is most clearly understood with reference to the following definitions:

As used in the specification and claims, the singular form “a”, “an” and “the” include plural references unless the context clearly dictates otherwise.

As used herein, the term “comprising” or “including” is intended to mean that the compositions, methods, devices, apparatuses and systems include the recited elements, but do not exclude other elements. “Consisting essentially of”, when used to define compositions, devices, apparatuses, systems, and methods, shall mean excluding other elements of any essential significance to the combination. Embodiments defined by each of these transition terms are within the scope of this invention.

USP shall be understood to mean U.S. patent Number, namely a U.S. patent granted by the U.S. Patent and Trademark Office.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIG. 1A is an axonometric view of an exemplary camshaft for use in the exemplary internal combustion engine.

FIG. 1B is an illustrative view of a full width camshaft bearing support structure as described in U.S. Patent Application Publication No, US 2009/0235887.

FIG. 1C is an illustrative view of another full width camshaft bearing support structure as described in U.S. Patent Application Publication No. US 2010/0012059.

FIG. 1D is an illustrative view of the bearing raceway for the bearing embodied in the full width camshaft bearing support structure of either FIG. 1B or C and more particularly showing the lubrication channel in the upper bearing raceway.

FIG. 1E is a cross-sectional view of the full width camshaft bearing support structure of either FIG. 1B or C showing the drawn cup outer raceway design embodied therein to control bearing axial motion.

FIG. 2A is a cross-sectional view of a cylinder and cylinder block of an exemplary internal combustion engine.

FIG. 2B is an illustrative view of an exemplary Type I valve train with tappets.

FIG. 2C is an axonometric view of the lower bearing support structure of a Type I valvetrain with the bearing, valve assembly, camshaft and upper bearing support structure omitted for clarity.

FIG. 2D is a pictorial illustrative view of the lower and upper support structure with the hydrodynamic bearing, tappets and camshaft omitted for clarity.

FIG. 3A is an axonometric view of the lower bearing support structure according to the present invention for a Type I valvetrain with the a portion of the outer raceway of the roller type bearing, where the valve assembly, the camshaft and upper bearing support structure are omitted for clarity.

FIG. 3B is a top view of the lower bearing support structure of FIG. 3A.

FIGS. 3C, D are, respectively, a side view of the lower bearing support structure of FIG. 3A (FIG. 3C) and an illustrative view of the of the lower bearing support structure of FIG. 3A (FIG. 3D) that show adequate clearance between bearing cutout and bucket tappet, with valve train assembled and bucket tappet on cam base circle.

FIG. 4A is an illustrative view of a portion of the rotating bearing support structure of the present invention, including the mechanism for securing the bearing cage to the bearing inner raceway and a portion of the camshaft.

FIG. 4B is a more detailed illustrative view of FIG. 4A that shows the angled tabs on the bearing cage located on the bearing inner raceway on the camshaft.

FIG. 4C is an illustrative view of the portion of the rotating bearing support structure shown in FIG. 4A and including the bearing outer raceway when disposed on the bearing cage.

FIG. 4D is an illustrative view of the rotating bearing support structure including the camshaft bearing support cap when secured to the cylinder head cover.

FIG. 5 is a perspective illustrative view of the split type outer raceway.

FIG. 6A is an axonometric view of a camshaft bearing support cap showing the lubricant feed channel.

FIG. 6B is an axonometric view of another camshaft bearing support cap showing another lubricant feed channel arrangement.

FIGS. 7A, B are perspective views with a partial cut-away of the rotating bearing support structure and the related cylinder head structure.

FIG. 8A is an exploded view of the rotating bearing support structure and the related cylinder head structure associated with a Type I valvetrain.

FIG. 8B is an illustrative view of a single side split cage which enables assembly of a roller bearing onto the camshaft, more particularly, onto the inner raceway.

FIG. 9 is an illustrative section view showing the reduction of section width across lower bearing panel or support structure and the variation from full width to reduced width.

FIG. 10 is an illustrative side view of the roller bearing depicting camshaft bearing loading.

FIG. 11 is an illustrative view of the lower bearing support structure further illustrating the variation from full width to reduced width.

FIG. 12 is a graphical view representative of expected frictional reductions as a function of valve train speed (rpm) when the camshaft in a Type I valvetrain is rotatably supported by the roller bearing support structure of the present invention.

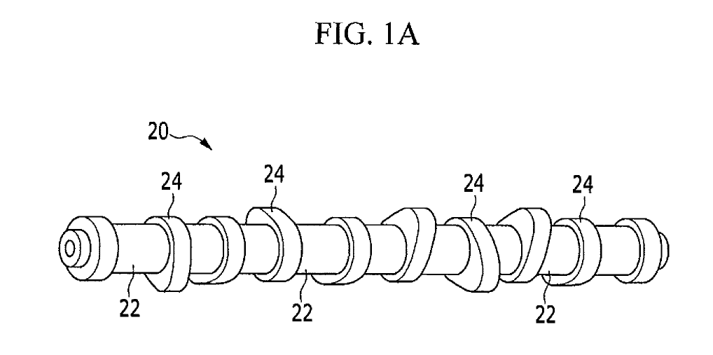

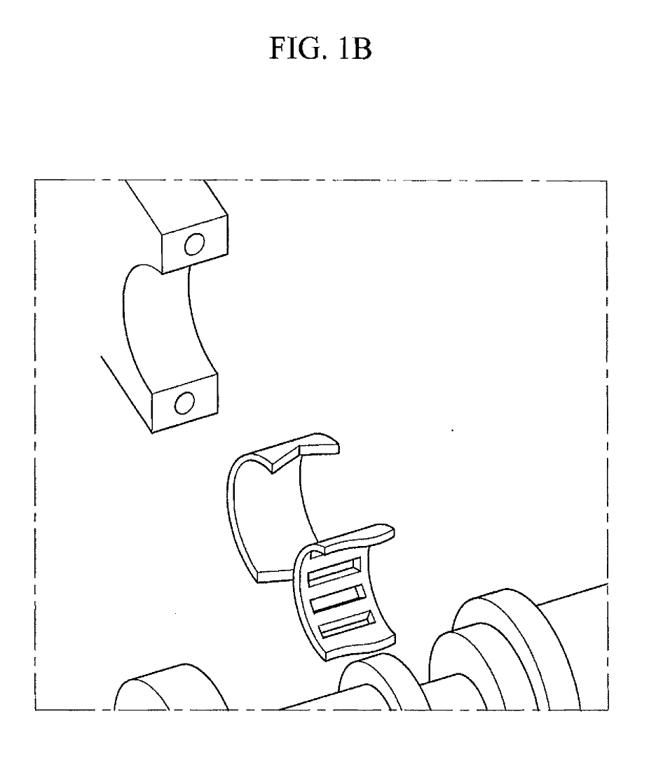

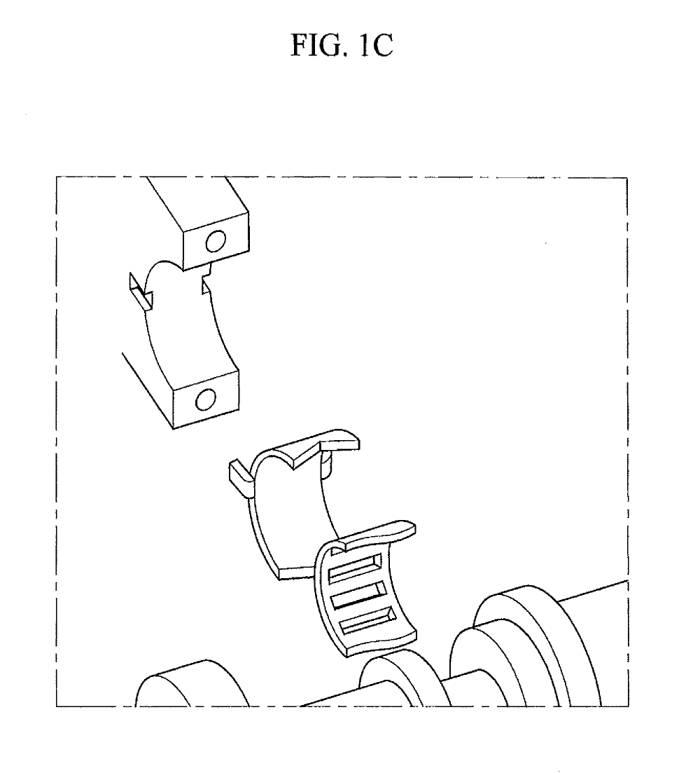

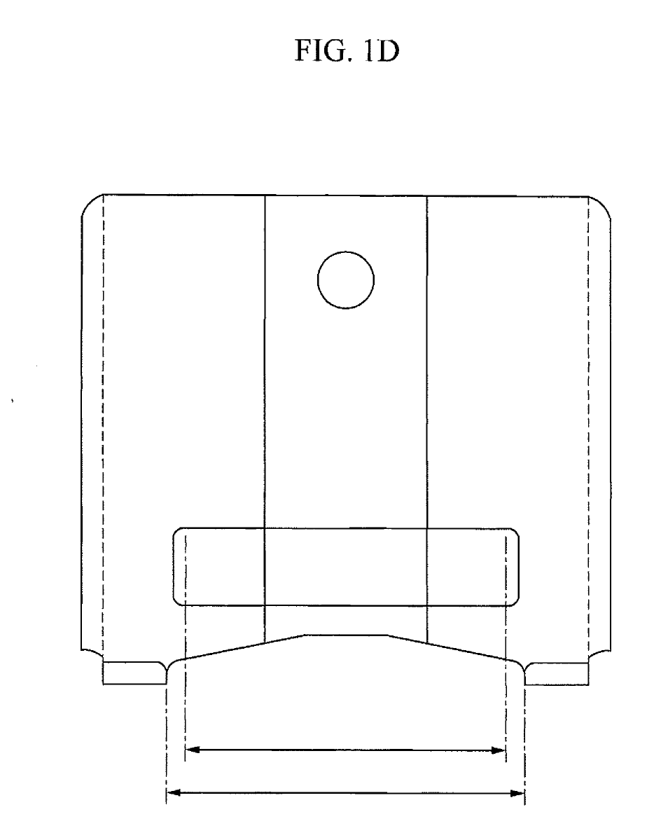

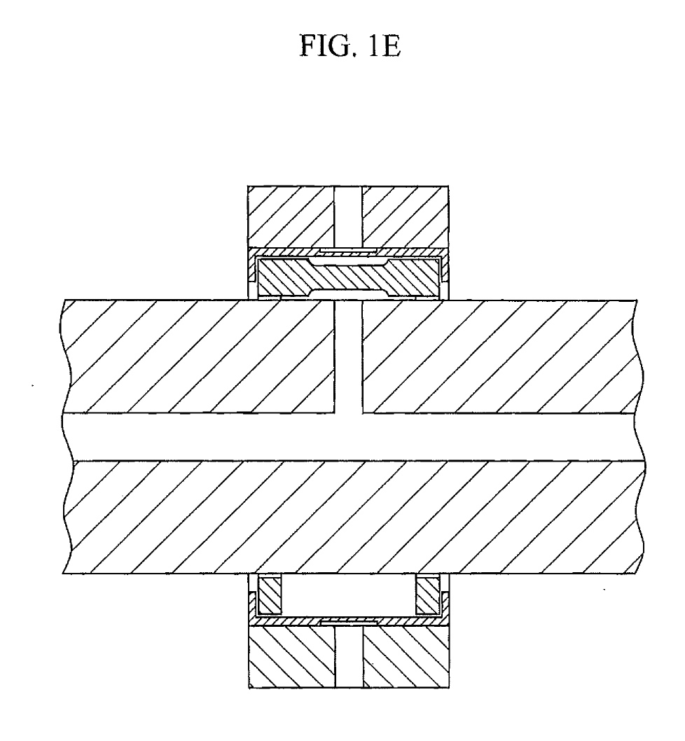

### DESCRIPTION OF THE PREFERRED EMBODIMENT

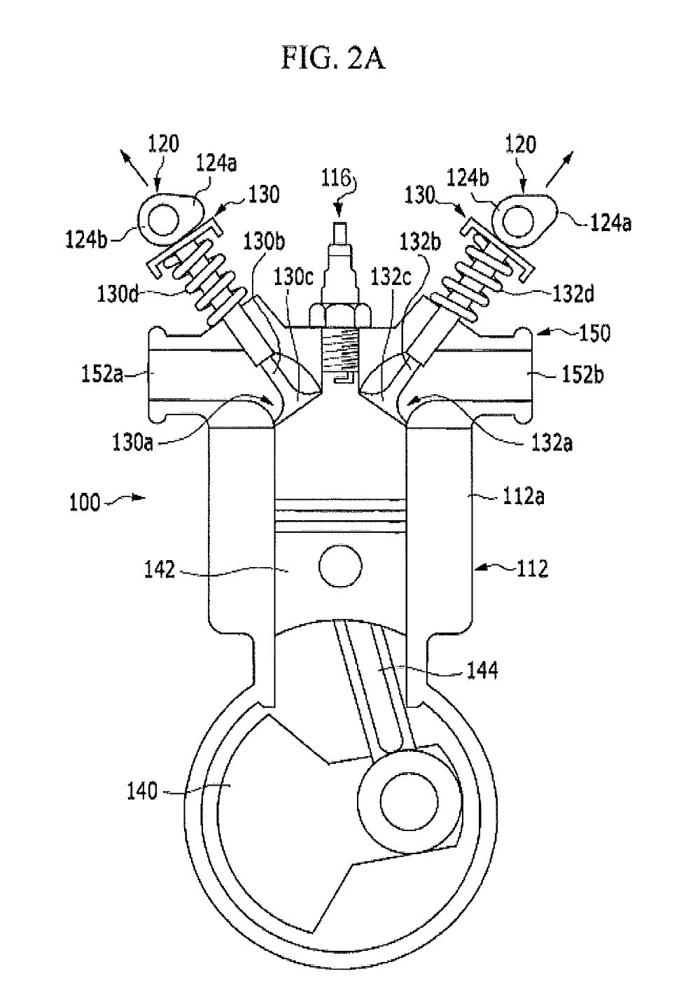

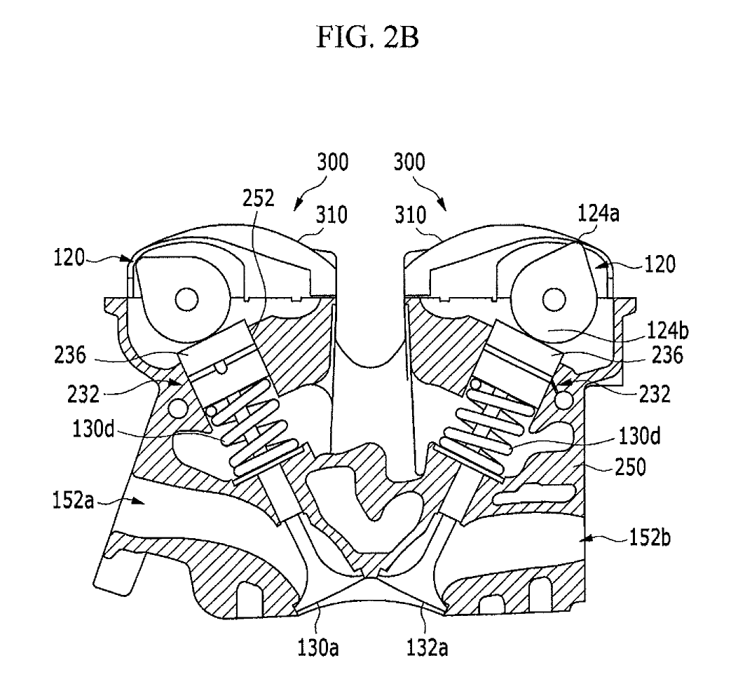

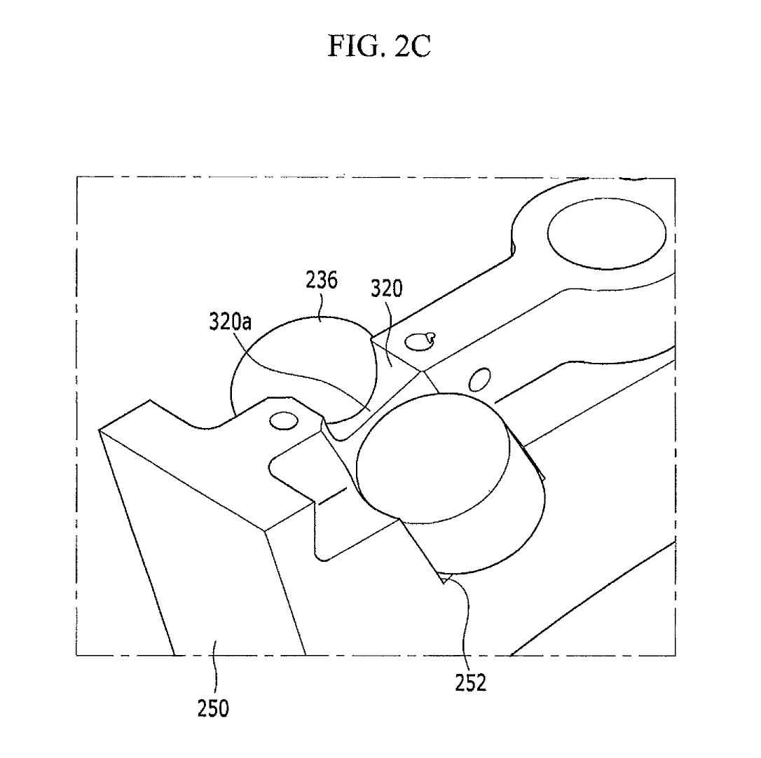

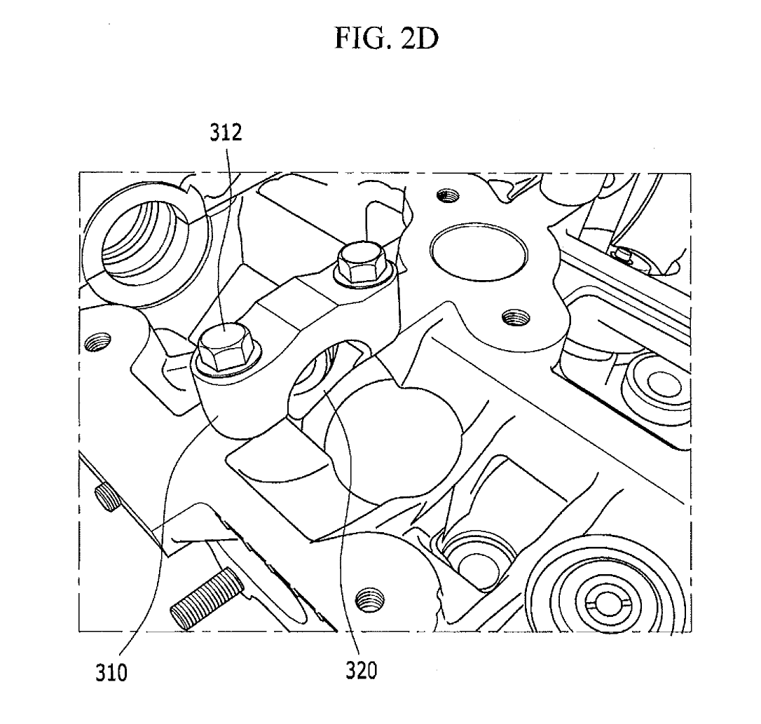

Referring now to the various figures of the drawing wherein like reference characters refer to like parts, there is shown in FIG. 2A a cross sectional view of a cylinder of an exemplary internal combustion engine 100 that includes a camshaft 120 that is used in such an internal combustion engine for separately moving the intake valve(s) 130a and exhaust valve(s) 132a respectfully of the intake and exhaust valve assemblies 130, 132. Such an exemplary internal combustion engine also includes a cylinder block 112, a crankshaft 140, and a piston 142, that reciprocate within a cylinder 112a of the cylinder block.

Although a single cylinder 112a and piston 142 are depicted in the cross-section, as is known to those skilled in the art the cylinder block 112 of such a reciprocating engine or internal combustion engine 100 is configurable so as to include 4 cylinders, 6 cylinders, 8 cylinders, 10 cylinders and 12 cylinders, and where the number of pistons corresponds to the number of cylinders. Also, the cylinders are arranged in the engine or cylinder block so as to be in a line, slanted, to form a V, or arranged in any of a number of ways as one known to those skilled in the art.

Such an internal combustion engine 100 is a reciprocating engine with a cylinder block 112 and a cylinder head 150 as housings, a motion conversion mechanism to convert the reciprocal motion of the piston(s) 142 to rotary motion, a supply and exhaust system to supply an air-fuel mixture and to exhaust the combustion gas, and a spark plug 116 as an ignition device. As is known to those skilled in the art, the cylinder head is secured to cylinder block so that portions of the supply and exhaust systems are in fixed relation to each cylinder 112a. The motion conversion mechanism is housed in the cylinder block 112 and includes the piston 142, the crankshaft 140 and a connecting rod or con-rod 144 having one end connected to the piston 142 and the other end connected to the crankshaft 140, to convert the reciprocating motion of the piston to rotary motion of the crankshaft.

As is known to those skilled in the art, the crankshaft 140 is in turn operably coupled to a transmission as is known in to those skilled in the art (e.g., mechanical, hydraulic, CVT, etc.) that is in turn operably coupled to the drive wheels (not shown) of a motor vehicle. In this way, the power/torque developed by operation of the engine is transmitted to the drive wheels so as to thereby cause the vehicle to move in a desired direction (e.g., forward, reverse).

The supply and exhaust system includes a supply path 152a and an exhaust path 152b that are formed in the cylinder head 150 and which are selectively fluidly coupled to each cylinder 112a of the cylinder block 112. The intake valve 130a is located between the cylinder 112a and the supply path 152a, the exhaust valve 132a is located between the cylinder 112a and the exhaust path 152b, and as described further herein the camshafts 120 are arranged so as to directly control the timing of the opening and closing of the intake and exhaust valves 130a, 132a.

The intake valve assembly 130 includes an intake valve 130a, having a valve stem 130b and a valve head 130e provided at one side end of the valve stem 130b, and a valve spring 130d that forces the intake valve 130a in a direction in which the supply path 152a is closed. The exhaust valve assembly 132 includes an exhaust valve 132a, having a valve stem 132b and a valve head 132c provided at one side end of the valve stein 132a, and a valve spring 132d that forces the exhaust valve 130a in a direction in which the exhaust path 152b is closed. The camshaft 120 is connected to the other side end of either valve stem 130b, 132b so as to directly act on the valve stem so as to thereby control the opening and closing respectively of the intake and exhaust valves 130a, 132a.

The camshaft 120 that is used in the internal combustion engine 100 includes a shaft part 122 and a plurality of cams 124. The shaft part 122 is rotatably supported by one or more bearings and counterpart structure of the cylinder head 150 as further discussed herein. The camshaft 120 is connected to the crankshaft 140 by a timing belt (not shown) or other structure (e.g., gears), such that the camshaft rotates according to the rotation of the crankshaft.

As each cam 124 is operably coupled or connected respectively to an intake valve 130 or an exhaust valve 132, the same number of cams is provided as the number of valves 130,132. Each cam 124 includes a relatively long diameter part 124a, sometimes referred to as a lobe, and a relatively short diameter part 124b. The plurality of cams 24 are arranged along the camshaft 120 in such a way that the positions of the long diameter parts 124a are shifted in a circumferential direction. Thus, the intake and exhaust valves 130,132 as they are operably connected to each of the plurality of cams 124, can be opened and closed at different timings responsive to rotation of the respective camshaft 120.

The internal combustion engine 100 depicted in FIG. 2A is a Double Over Head Camshaft (DOHC) engine in which two camshafts 120 are provided and arranged on the upper side of the cylinder head 150 and so as to be on each side of the intake valve 130 and the exhaust valve 132. In such a DOHC configuration, the cams of one camshaft are operably coupled to the intake valve(s) 130 so as to respectively open and close each intake valve at the appropriate timing and the cams of the other camshaft are operably coupled to the exhaust valve(s) 132 so as to respectively open and close each exhaust valve at the appropriate timing. However, as is known to those skilled in the art, such an internal combustion also is configurable so as to include one camshaft 120 (i.e., a single overhead camshaft—SOHC) that includes cams that are arranged along the camshaft so as to open and close each of the intake and exhaust valves 130, 132 at the appropriate timing.

The following discussion is provided to generally describe operation of such an exemplary internal combustion engine 100 (after then engine has been started). The exemplary internal combustion engine 100 is a four-cycle internal combustion engine having four steps such as a supply or intake step, a compression step, a combustion step, and an exhaust step. In such a exemplary engine, a step in which the piston 142 is moved between the highest position (i.e., top dead point or top dead center) and the lowest position (i.e., bottom dead point or bottom dead center) in the cylinder 112a is one step or cycle of the engine.

In the supply or intake step, the piston 142 is moved from top dead center to bottom dead center while the supply valve 130 is opened and the exhaust valve 132 is closed. As the volume inside of the cylinder 112a (that designates an upper space of the piston 142 hereinafter) is increased, the pressure therein is lowered, and an air-fuel mixture is introduced through the supply path 152a to the inside of the cylinder 112a. The other portions of the supply system are configured and arranged so as to mix the fuel and air mixture that is to be supplied to each supply path 152 in the cylinder head(s). Such a supply system can be arranged so as to provide a pressurized source of a fuel-air mixture using supercharging or turbo-supercharging techniques.

In the compression step, the piston 142 is moved from bottom dead center point to top dead center while the intake and exhaust valves 130, 132 are closed. As the volume inside of the cylinder 112a is decreased by such motion, the pressure in the cylinder therein is raised or increased.

In the combustion step, the spark plug 116 is ignited while the intake and exhaust valves 130, 132 are closed which causes the air-fuel mixture in the compressed state to burn and expand abruptly. Such expansion pushes the piston 142 downwardly from top dead center to bottom dead center. The force from this downward motion of the piston is transferred to the crankshaft 140 through the con-rod 144 as rotary motion, whereby drive force is generated by the engine.

In the case of a diesel engine, the engine may include means (e.g., a glow plug) that facilitates ignition of the diesel fuel-air mixture when the engine is initially started, however, during normal operation, the diesel fuel-air mixture is compressed sufficiently during the compression step so as to cause the fuel-air mixture to ignite.

In the exhaust step, the piston 142 is moved from bottom dead center to top dead center while the supply valve 130 is closed and the exhaust valve 132 is opened. The volume inside the cylinder 112a is reduced by such motion thereby causing the combustion gas to be discharged to the exhaust path 152b. When the piston 142 reaches the top dead center, the above described four-cycle process is repeated continuously until the engine is turned off. The other portions of the exhaust system are configured and arranged so as to facilitate movement or discharge of the hot combustion gases to atmosphere.

When the intake valve is described as being opened in the above steps, the long diameter part 124a of the respective cam 124 abuts a respective end of the intake valve 130a. In this way, the intake valve 130a is pushed downward against the force of the valve spring 132d, thereby causing the intake valve head 130c to be displaced from the valve seat and extend into the cylinder 112a. When the intake valve is described as being closed, the short diameter part 124b of the cam 124 abuts the respective end of the intake valve 130. In this configuration, the intake valve 130a is pushed upward by the restoring force of the valve spring 130d thereby causing the intake valve head 130c to be into contact with the valve seat, closing the pathway. This also applies for the exhaust valve 132 and thus, its description will not be repeated here.

Among the above steps, the drive force is generated only in the combustion step, and in the other steps, the piston 142 of one cylinder is reciprocated by the rotation of the flywheel (not shown) and/or the drive force generated in another cylinder if the engine includes more than one cylinder. Therefore, the combustion steps are shifted in terms of time by the plurality of cylinders to maintain a smooth rotation of the crankshaft 140.

Referring now to FIG. 2B, there is shown a cross-sectional view of a cylinder head 250 illustrating an exemplary Type I valve train with tappets. Reference shall be made to the foregoing discussion regarding FIG. 2A for features (e.g., features of the valve train) having common reference numerals. Also, as shown in FIG. 2A, such a cylinder head 250 is secured to the engine block 112, typically by bolts. In addition, the cylinder head 250 and engine block 112 are secured to each other so that the selected ports or openings in each of the cylinder head and engine block correspond to each other so that engine coolant and lubricant (pressurized oil) is provided to the cylinder head from the engine block.

Also included is an intake valve assembly 230 that includes an intake valve 130a, having a valve stem 130b and a valve head 130c provided at one end of the valve stem 130a, and a valve spring 130d that forces the intake valve 130a in a direction in which the supply path 152a is closed. Such an intake valve assembly also includes a tappet 236 that is disposed between the cam 124 and the other end of the intake valve 130a. In use, the long diameter part 124a of the cam 124 acts on the tappet 236 so as to cause the intake valve 130a to move into an open position. Correspondingly, when the short diameter part 124b is opposed to the tappet 236, the valve spring 130d causes the intake valve 130a to move towards and into contact with the valve seat embodied in the cylinder head 250, thereby moving the intake valve to a closed position.

The exhaust valve assembly 232 includes an exhaust valve 132a, having a valve stem 132b and a valve head 132c provided at one side end of the valve stem 132b, and a valve spring 132d that forces the exhaust valve 130a in a direction in which the exhaust path 152b is closed. Such an exhaust valve assembly also includes a tappet 236 that is disposed between the cam 124 and the other end of the valve stem 132b. In use, the long diameter part 124a of the cam 124 acts on the tappet 236 so as to move the exhaust valve 132a to into an open position. Correspondingly, when the short diameter part 124b is opposed to the tappet 236, the valve spring 132d causes the exhaust valve 132a to move towards and into contact with the valve seat embodied in the cylinder head 250, thereby moving the exhaust valve to a closed position.

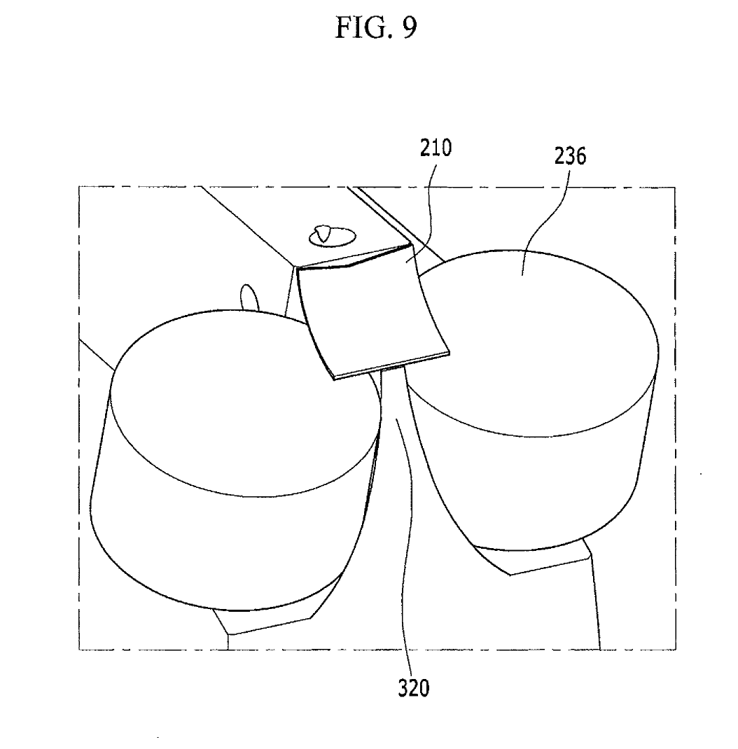

As shown more clearly in FIG. 2C, each tappet 236 is located in a pocket 252 formed or machined in the cylinder head 250 so that the tappet moves linearly responsive to the rotary motion of the cam 124. As also shown in FIG. 2C, such machining or forming of the cylinder head 250 for such pockets 252 causes the lower bearing support element 320 of the bearing support structure 300 to have a width that varies circumferentially. In more particular embodiments, the width varies between a maximum width and a minimum width, the minimum width generally corresponding to a location proximal to the tappet 236 when it is disposed in the pocket 252. The section view of FIG. 9, more clearly shows the reduction in section width across the lower bearing support element 320 and the positioning of the outer raceway 210 with respect to the tappets 236 and the lower bearing support element. As shown in other views, the width of the lower bearing support element grows to full width for good overall support characteristics.

Such a bearing support structure 300 also includes an upper bearing support element 310. The upper bearing support element, as show in FIG. 2D is bolted to a mating surface of the cylinder head 250 using bolts 312. The width of the upper bearing support element 310 is essentially constant or unchanging. More particularly, the upper bearing support element 310 has a nominal width.

In further embodiments, the width of the upper bearing support element 310 is generally larger than the width of the lower bearing support element 320. In further embodiments, the widths of the upper and lower bearing support elements 310,320 satisfy the following relationship the minimum width of the lower support element (Wₗₛₑ) divided (/) by the upper support element width (Wᵤₛₑ) is in the range of from about 30% to about 50% (i.e., about 30%≦Wₗₛₑ/Wᵤₛₑ≦about 50%).

In yet further embodiments, the lower support element width varies circumferentially so as to vary between a minimum width and a maximum width. In yet more particular embodiments, the width of the upper bearing support element 310 is generally larger than the width of the lower bearing support element 320 at the position 320a corresponding to the minimum width of the lower bearing support element 320.

In yet further embodiments, the widths of the upper bearing support element 310 Wᵤₛₑ) and lower bearing support element 320 (Wₗₛₑ) satisfy one of the following relationships:

(a) about 30%≦Wₗₛₑ/Wᵤₛₑ≦about 50%;

(b) Wₗₛₑ/Wᵤₛₑ≦about 50%; or

(c) Wₗₛₑ/Wᵤₛₑ≧about 30%.

The bearing support structure 300 also includes a rollerized bearing 400 which is maintained in secure arrangement between the upper and lower bearing support elements 310, 320 when the upper bearing support element 310 is secured or bolted to the cylinder head 250. Such a rollerized bearing includes an outer raceway 410, a inner raceway 420, a plurality, more specifically a multiplicity of roller or rolling elements 430, and a cage 440. As described further herein, such a rollerized bearing uses a split out shell concept to provide full support to the rollers 430 over 360 degrees of rotation.

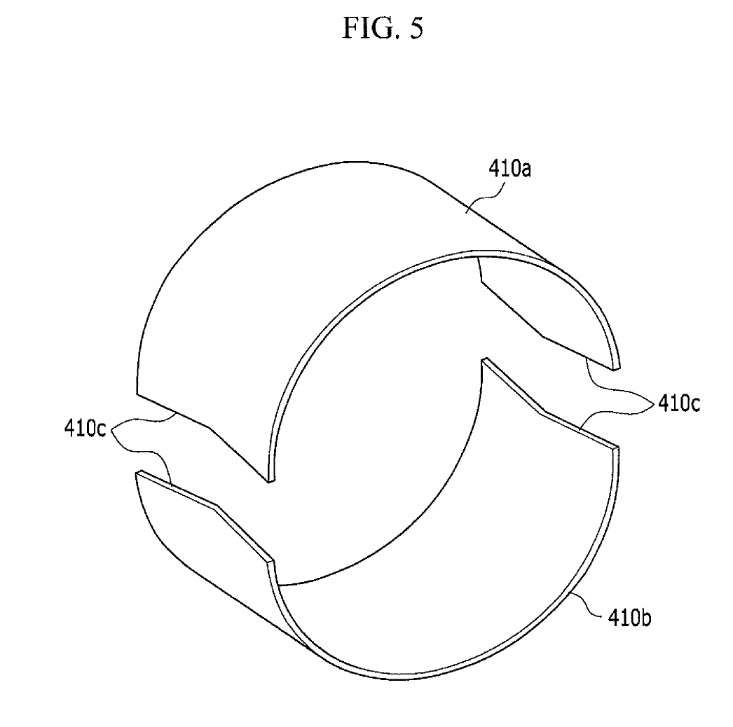

As shown in FIG. 5, in particular embodiments the outer raceway 410 is in two circumferential parts 410a, 410b so as to form a split type outer raceway. In further embodiments, the ends 410c of the split type outer raceway are arranged so as to form an angled split as an aid for assembly alignment. The inner raceway 420 preferably is similarly configured as the outer raceway 410 so as to form a split type raceway.

In more particular embodiments, each of the outer and inner raceways 410, 420 are configured so that the widths of each are relatively unchanging about the circumference of the raceway. More specifically, the each of the inner and outer raceways has a respective nominal width. In addition, the outer and inner raceways are made of any of a number of materials known to those skilled in the art and otherwise appropriate for the intended use.

The inner raceway 420 is disposed about the surface of the shaft part 122 of the camshaft 120. When the rollerized bearing 400 is assembled about the shaft part 122 and secured by the upper and lower beating support elements 310, 320, the inner raceway 420 is in mating contact with the shaft part 122.

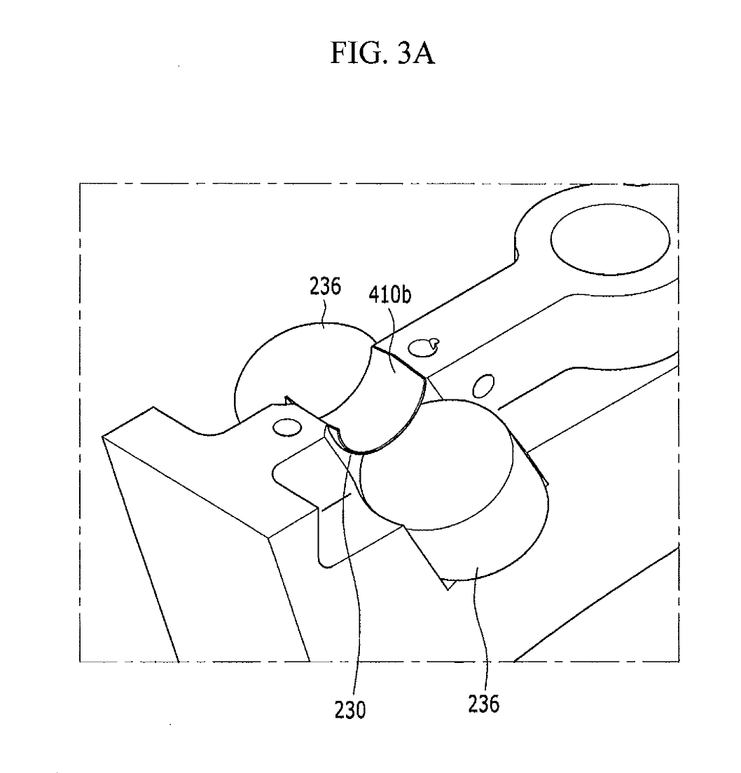

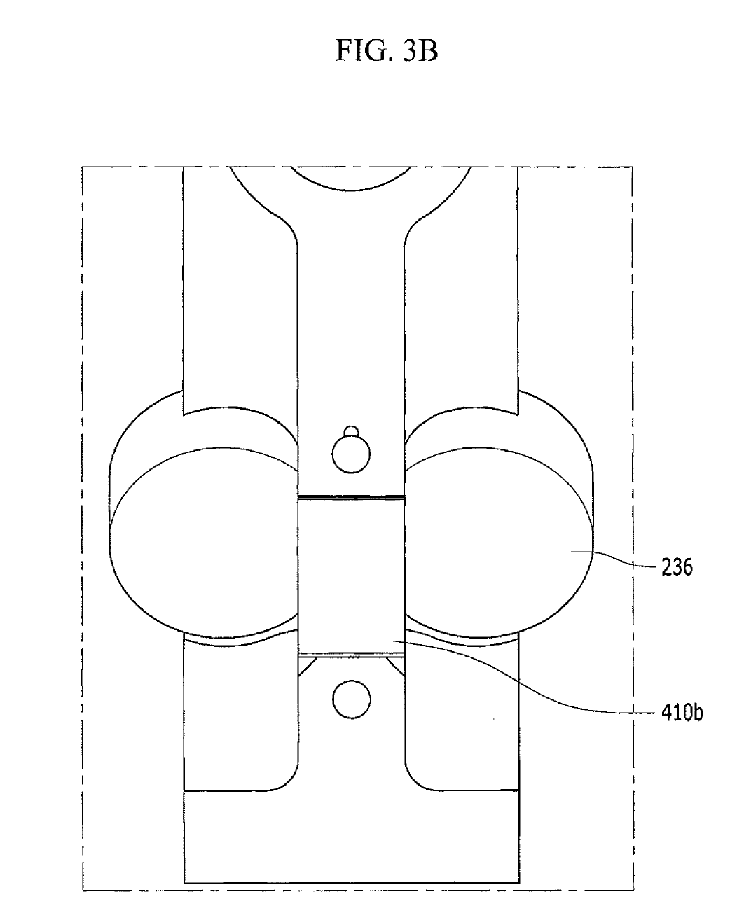

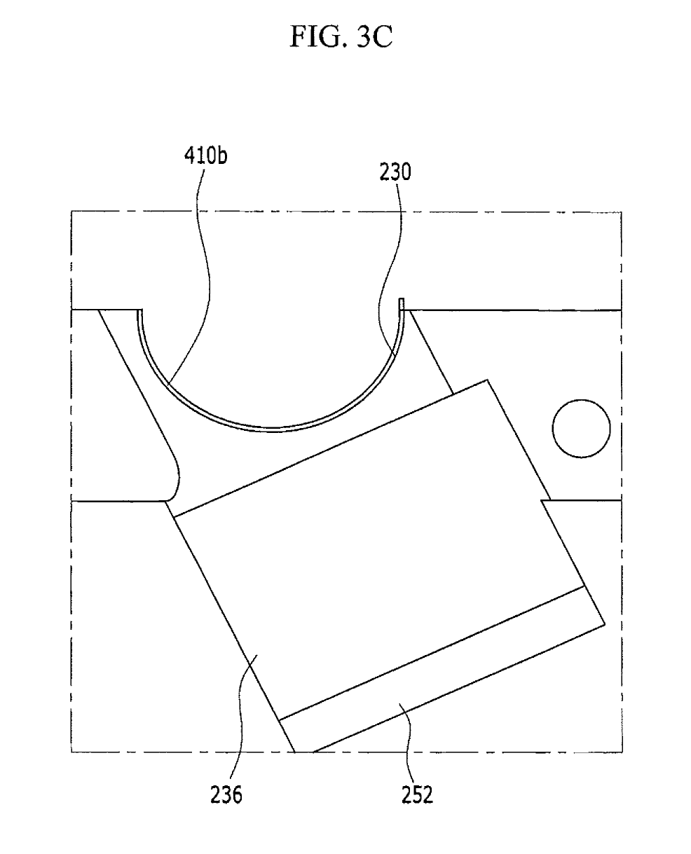

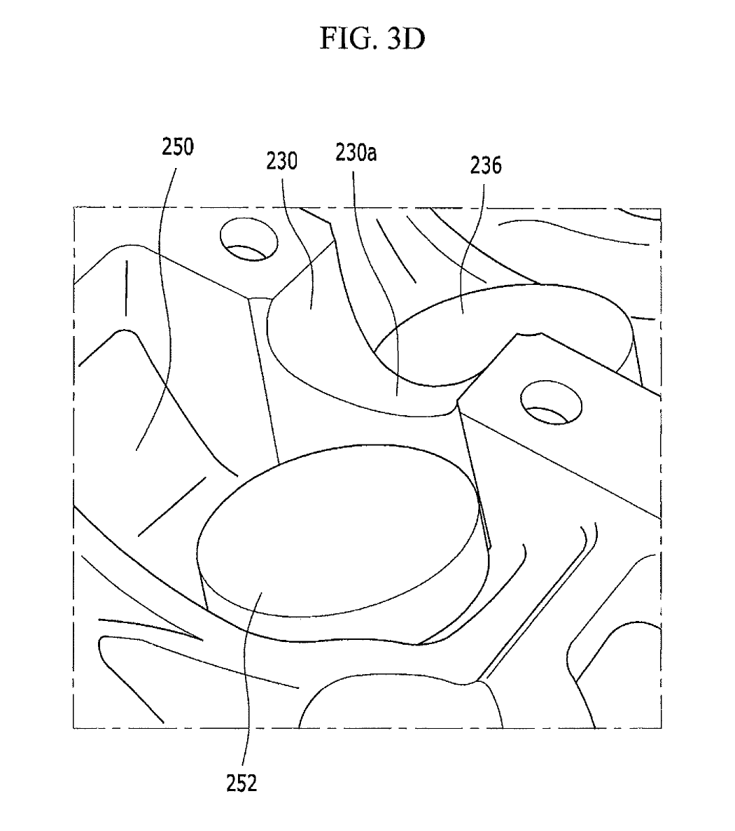

As shown in FIGS. 3A-C one part 410b of the outer raceway 410 is positioned so as to be in contact with the lower bearing support element 320 and the other part 410a is positioned so as to be in contact with the upper bearing support element 310. When the rollerized bearing 400 is assembled about the shaft part 122 and secured by the upper and lower bearing support elements 310, 320, the outer raceway 410 is in mating contact with opposing surfaces for the upper and lower bearing support elements 310, 320.

The roller cage 440 is configured and arranged so as to include a plurality, more specifically a multiplicity of slots 442 that extend widthwise but not across the entire width of the roller cage. The slots 442 form through apertures in the roller cage 440. A roller is deposed in each of the slots 442 so that the roller or rolling elements are maintained in spaced relation about the circumference of the roller cage.

When assembled the roller cage 430 is located between the outer and inner raceways 310, 320 so that the rolling elements are in rolling contact with the outer and inner raceways. These rollers allow the camshaft to rotate. As is known to those skilled in the art, the rollers and roller cage also rotate about the camshaft during use. In further embodiments, the needle rollers 440 and roller cage 430 have a split cage arrangement which allows the assembly to be installed onto the camshaft easily.

In further embodiments, the roller cage 440 includes a plurality of tabs 432 that extend at an angle (e.g., perpendicular) with respect to the end surface 434 of the cage and downwardly and/or upwardly from such end surfaces 434. More particularly, the tabs are arranged so that they extend in a direction so as to abut or be proximal to a corresponding end surface 21 of the inner raceway 220. These tabs 432 or locating tabs are positioned so to prevent the bearing/cage assembly 430,440 from moving axially on the inner raceway.

In yet further embodiments, the tabs 432 are arranged so as to abut or be proximal to an end surface of the outer raceway 410 so as to prevent such axial movement. In yet further embodiments the tabs 432 are arranged so as to selectively abut or be proximal to an end surface of the outer raceway 410 and the inner raceway 420. In yet further embodiments, the end surface of the inner and or outer raceways are chamfered. Thus, the tabs 432 are arranged so as to complement such a chamfer.

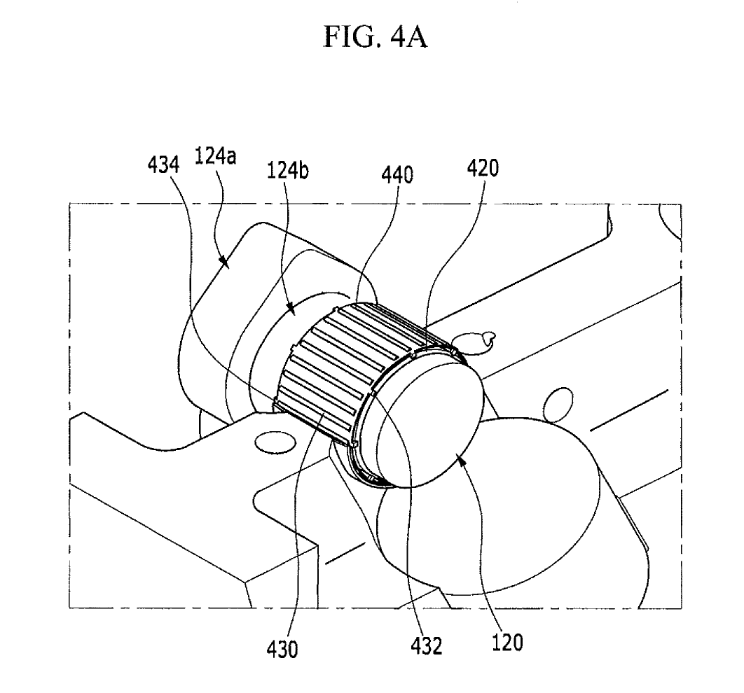

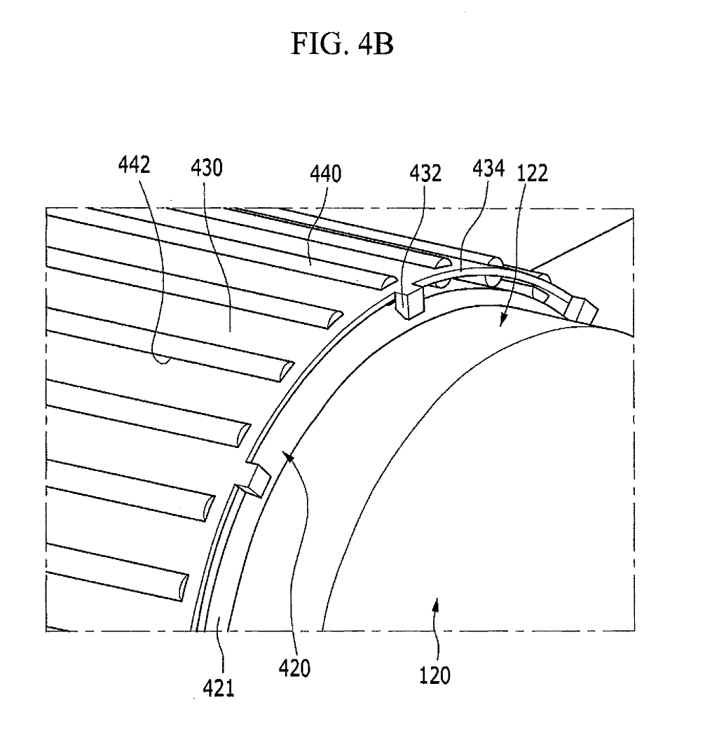

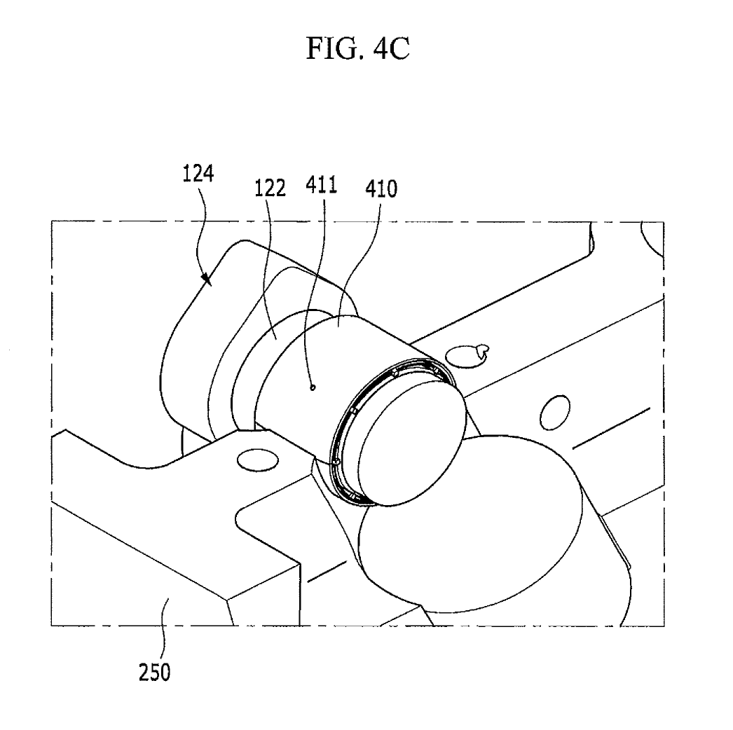

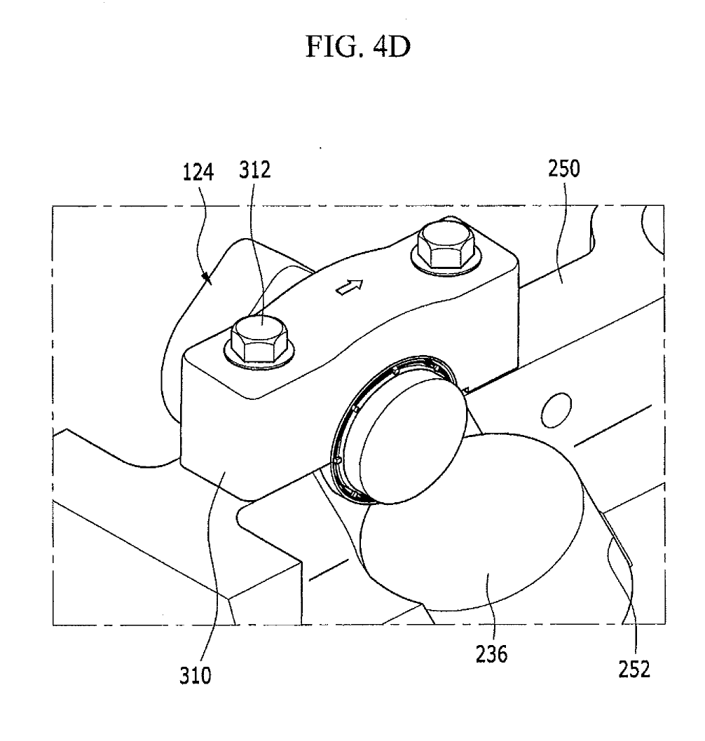

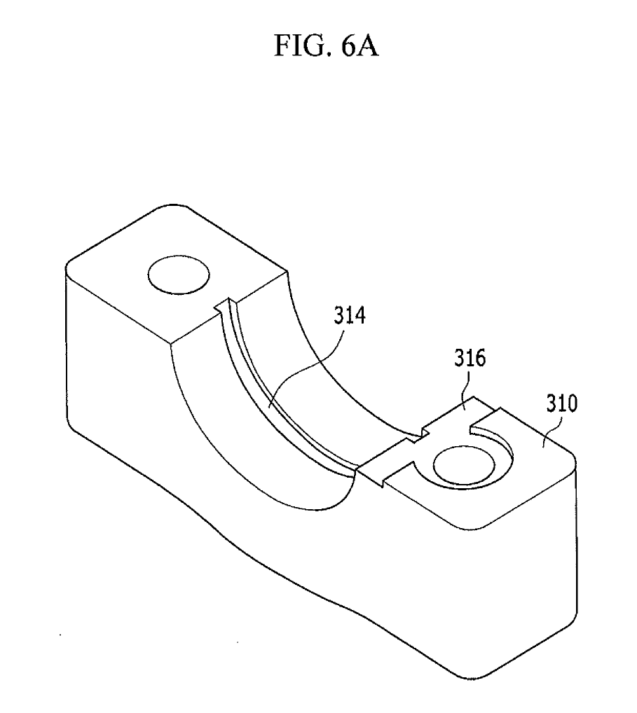

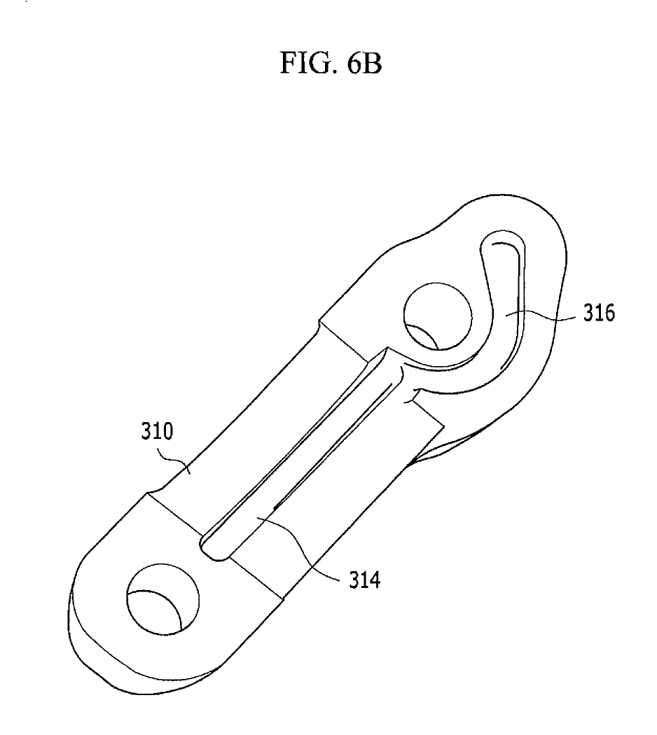

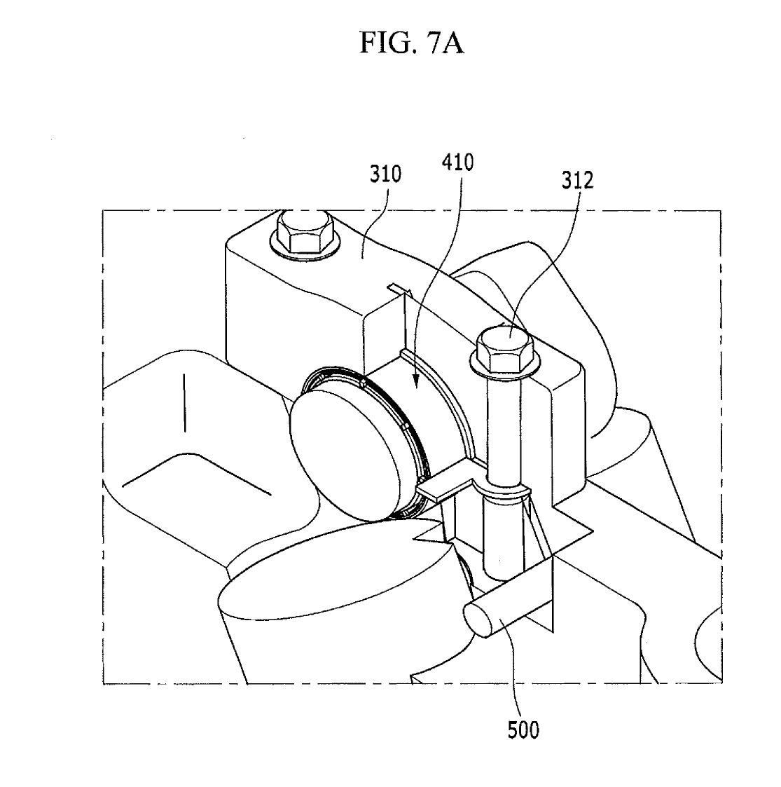

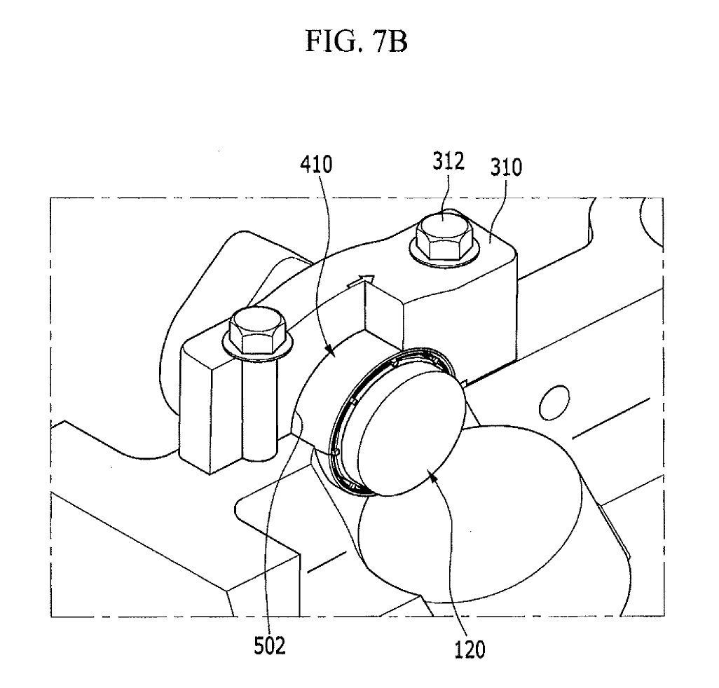

In yet further embodiments, a through aperture 411 is provided in the outer raceway 410 (see FIG. 4C) and the upper bearing support element 310 is configured so as to include a channel 314 in the surface that opposes the outer raceway. The channel 314 and through aperture 411 are arranged so that the through aperture is fluidly coupled to the channel. As described further herein, the channel 314 is fluidly coupled to a source of lubricant (e.g., pressurized oil). Thus, while the engine is in operation, lubricant is provided to the rollers 430 or rolling elements via the channel 314 and through aperture 411, such as illustrated in FIGS. 6A,B.

In addition, and as illustrated in FIG. 6B, the upper bearing support element can be configured with one or more cut outs 316 that communicate with a lubrication passage in the cylinder head. In this way, lubricant is supplied to each of the tappets 236.

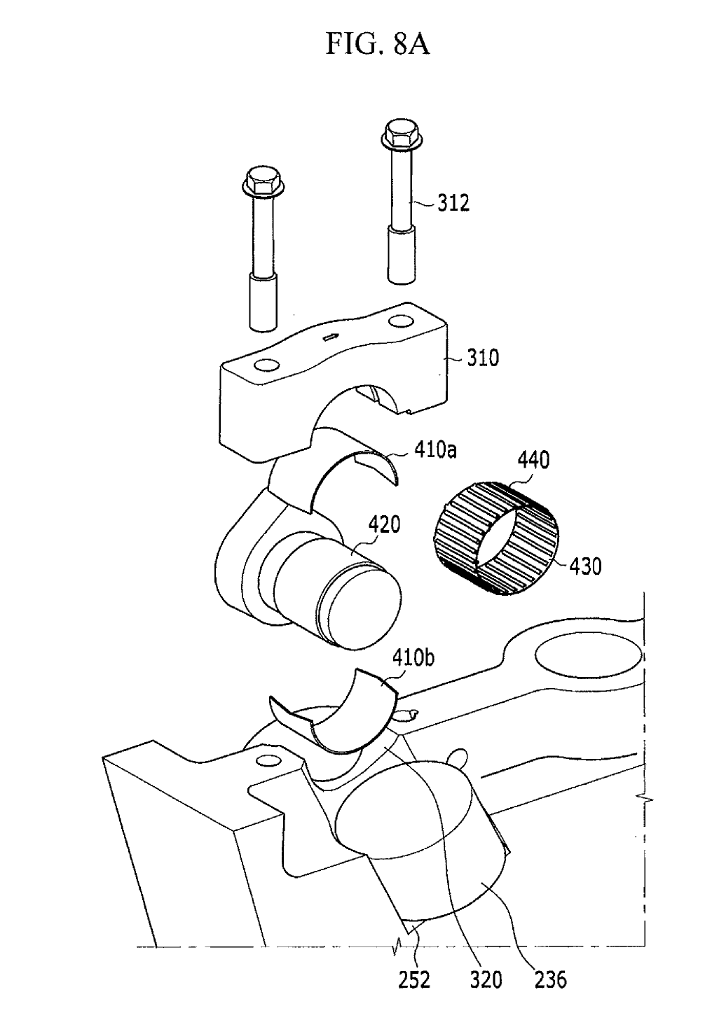

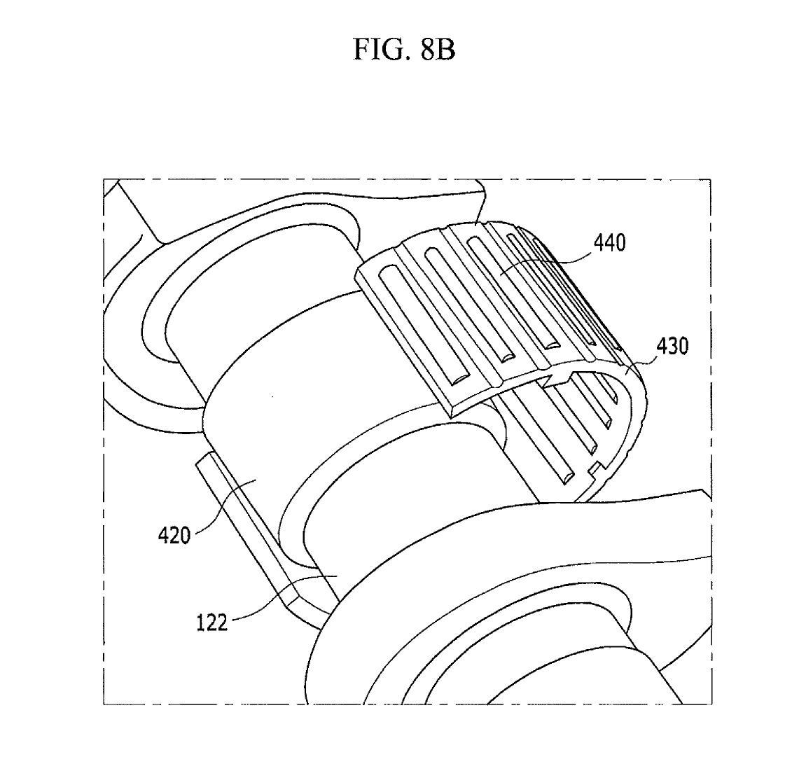

The following describes an exemplary methodology for assembling a bearing support about the camshaft at one location. Thus, it should be understood that such a methodology would be undertake at each location where rotating support is provided for the camshaft. Reference shall be made to the exploded view shown in FIG. 8A along with the following description.

After the bucket tappets 236 are installed, insert one portion 410b of the outer raceway 410 into lower bearing support element 230. Then install the assembly of the rollers 430 and the roller cage 440 onto inner raceway 420 which is also installed onto the camshaft 122. This is repeated as many times as is required so that an assembly is located at each lower bearing support elements of the cylinder head prior to installation of the camshaft.

After completing the foregoing, the camshaft is installed so that the shaft parts 122 of the camshaft are appropriately positioned. Thereafter, the other portions of the inner raceway 420 and the rollers 430 and cage 440 are located about the camshaft 120. Then, the other portion 410a of the outer raceway 410 are disposed about the assembled roller and roller cage. As indicated herein, the ends 430c of the two portions of the outer raceway 410, provide a mechanism to facilitate alignment of these two portions.

As discussed herein and as shown in FIG. 8B, the single side split cage design enables easily assembly of the roller/roller cage 430,440 onto the camshaft, more specifically onto inner raceway 420.

The upper bearing support element 310 is positioned at the corresponding mating surface of the cylinder head 250. The upper bearing support element 310 is then secured to the cylinder head using the mounting bolts 312.

The foregoing process is repeated at each location of a lower bearing support element.

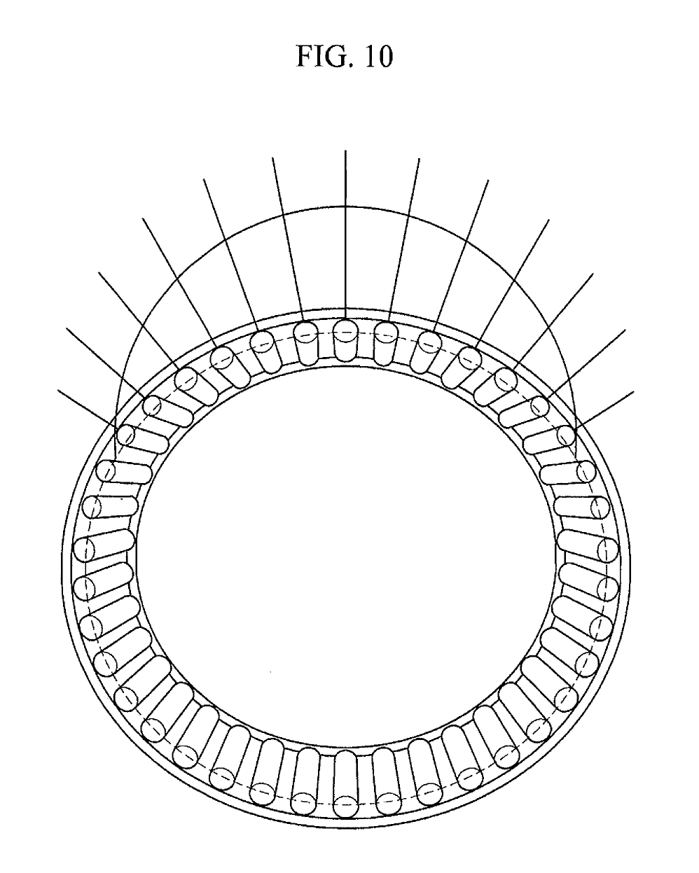

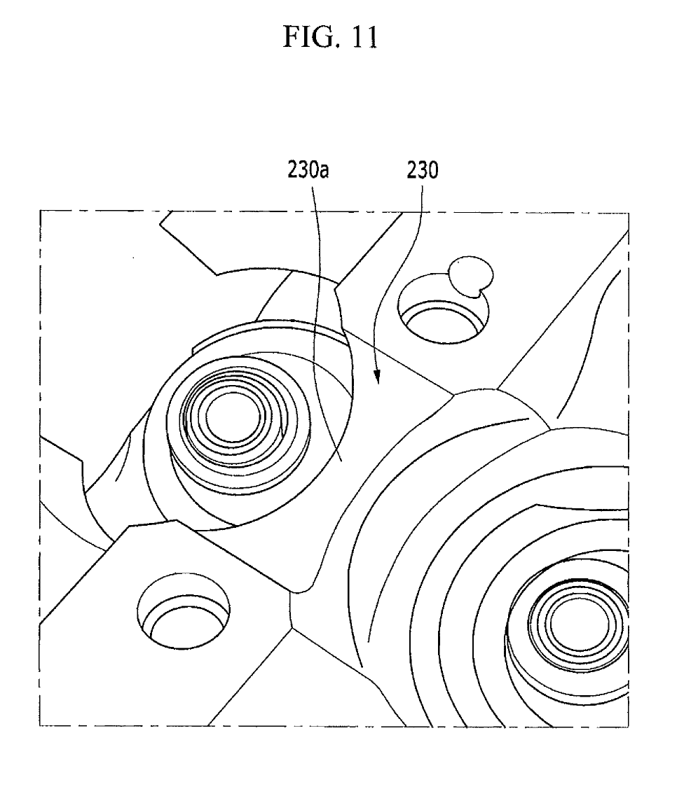

As illustrated in FIG. 10, the loading of the camshaft bearing dominates in the upper half of the bearing. Therefore, as the upper bearing support element 310 is in contact with across the entire width of the outer raceway 410, the upper bearing support element is capable of handling such loading. The loading of the camshaft in the lower half of the bearing is reduced as compared to the camshaft loading in the upper half of the bearing. Thus, the lower bearing support is capable of handling such loadings even with the reduced width.

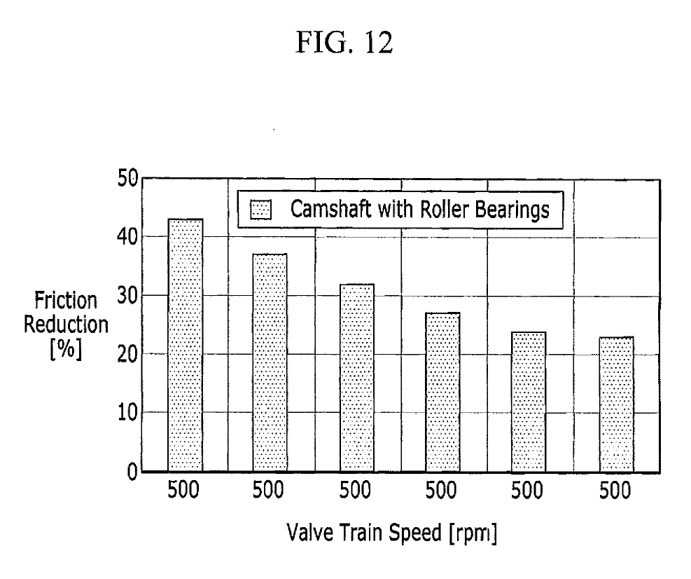

Referring now to FIG. 12, there is shown a graphical view representative of expected frictional reductions as a function of valve train speed (rpm) when the camshaft in a Type I valvetrain is rotatably supported by the roller bearing support structure of the present invention.

The reduced friction, particularly at low engine speeds can help improve fuel economy as well as improve on engine wear. Also, due to the significantly reduced lubrication requirements for a roller bearing according to the present invention it is possible to consider downsizing the engine oil pump which also can help improve fuel economy at low engine speeds

Although a preferred embodiment of the invention has been described using specific terms, such description is for illustrative purposes only, and it is to be understood that changes and variations may be made without departing from the spirit or scope of the following claims.

### INCORPORATION BY REFERENCE

All patents, published patent applications and other references disclosed herein are hereby expressly incorporated by reference in their entireties by reference.

### EQUIVALENTS

Those skilled in the art will recognize, or be able to ascertain using no more than routine experimentation, many equivalents of the specific embodiments of the invention described herein. Such equivalents are intended to be encompassed by the following claims.

What is claimed is:

1. A rollerized camshaft support to rotatably support a camshaft used with a Type I valvetrain, the camshaft having at least one cam for each intake valve and exhaust valve and at least one rotating surface, where the cams and the at least one rotating surface being positioned along the length of the camshaft, said rollerized camshaft support including:
at least one rollerized bearing, each said rollerized bearing having an inner raceway that extends circumferentially and axially about each of said at least one rotating surface, an outer raceway extending circumferentially and axially about the inner raceway; and a plurality of rolling elements disposed between the inner and outer raceways and extending widthwise across the raceways;
at least one bearing support for each of said at least one rollerized bearing, each of said at least one bearing support including a bearing upper support element and bearing lower support element;
wherein the bearing upper support element and bearing lower support element are configured so as to receive there between said at least one rollerized bearing; and
wherein the bearing lower support element is configured and arranged so to complement a portion of a configuration of the Type I valve train.

2. The rollerized camshaft support of claim 1, wherein:
the bearing upper support element has a first inner surface that opposes the inner raceway, the first inner surface having a first width (W₁);
the bearing lower support element has a second inner surface that opposes the inner raceway, the second inner surface having a second width (W₂);
the first width is larger than the second width; and
a width of the inner raceway is essentially unchanging.

3. The rollerized camshaft support of claim 2, wherein a ratio of the second width to the first width is in the range of about 30% to about 50%.

4. The rollerized camshaft support of claim 2, wherein the second width varies circumferentially so as to vary between a minimum width and a maximum width.

5. The rollerized camshaft support of claim 4, wherein the widths of the first width (W₁) and the second width (W₂) satisfy the following relationship:
about 30%≦W₂/W₁≦about 50%.

6. The rollerized camshaft support of claim 4, wherein the widths of the first width (W₁) and the second width (W₂) satisfy the following relationship:
W₂/W₁≧about 30%.

7. The rollerized camshaft support of claim 4, wherein the widths of the first width (W₁) and the second width (W₂) satisfy the following relationship:
W₂/W₁≦about 50%.

8. The rollerized camshaft support of claim 1, wherein each of said at least one rollerized bearing further includes a cage that is configured so the plurality of rolling elements are maintained in spaced relation circumferential and wherein the cage includes a plurality of tabs that extend perpendicular to a circumferential end surface of the cage so as to be proximal a circumferential end surface of one of the inner raceway or the outer raceway.

9. The rollerized camshaft support of claim 1, wherein:
the first inner surface of the bearing upper support element is configured with a channel that extends at least a part of the circumference of the inner surface, the channel being fluidly coupled to a source of lubricant;
the inner raceway is configured so as to include a through aperture; and
the channel is further arranged so as to be fluidly coupled to the through aperture.

10. The rollerized camshaft support of claim 1, wherein:
the camshaft includes a plurality of cams and a plurality of rotating surfaces; and
said rollerized camshaft support further includes a plurality of rollerized bearings and a plurality of supports; one rollerized bearing and bearing support for each of said plurality of rotating surfaces.

11. An internal combustion engine having a Type I valvetrain, at least one intake valve and at least one exhaust valve; said internal combustion engine including:
a camshaft having at least one cam for each intake valve and each exhaust valve and at least one rotating surface, where the cams and at least one rotating surface are positioned along the length of the camshaft;
a rollerized bearing support, one rollerized bearing support for each of said at least one rotating surface; and
wherein each of said rollerized bearing support includes:
at least one rollerized bearing, each said rollerized bearing having an inner raceway that extends circumferentially and axially about each of said at least one rotating surface, an outer raceway extending circumferentially and axially about the inner raceway; and a plurality of rolling elements disposed between the inner and outer raceways and extending widthwise across the raceways,
at least one bearing support for each of said at least one rollerized bearing, each of said at least one bearing support including a bearing upper support element and bearing lower support element,
wherein the bearing upper support element and bearing lower support element are configured so as to receive there between said at least one rollerized bearing, and
wherein the bearing lower support element is configured and arranged so to complement a portion of a configuration of the Type I valve train.

12. The internal combustion engine of claim 11, wherein:
the bearing upper support element has a first inner surface that opposes the inner raceway, the first inner surface having a first width;
the bearing lower support element has a second inner surface that opposes the inner raceway, the second inner surface having a second width;
the first width is larger than the second width; and
a width of the inner raceway is essentially unchanging.

13. The internal combustion engine of claim 12, wherein the widths of the first width (W_{I}) and the second width (W₂) satisfy the following relationship:
about 30%≦W₂/W₁≦about 50%.

14. The internal combustion engine of claim 12, wherein the second width varies circumferentially so as to vary between a minimum width and a maximum width.

15. The rollerized camshaft support of claim 14, wherein the widths of the first width (W₁) and the second width (W₂) satisfy the following relationship:
about 30%≦W₂/W₁≦about 50%.

16. The internal combustion engine of claim 14, wherein the widths of the first and second widths satisfy the following relationship:
W₂/W₁≦about 50%.

17. The internal combustion engine of claim 11, wherein each of said at least one rollerized bearing further includes a cage that is configured so the plurality of rolling elements are maintained in spaced relation circumferential and wherein the cage includes a plurality of tabs that extend perpendicular to a circumferential end surface of the cage so as to be proximal a circumferential end surface of one of the inner raceway or the outer raceway.

18. The internal combustion engine of claim 11, wherein:
the first inner surface of the bearing upper support element is configured with a channel that extends at least a part of the circumference of the inner surface, the channel being fluidly coupled to a source of lubricant;
the inner raceway is configured so as to include a through aperture; and
the channel is further arranged so as to be fluidly coupled to the through aperture.

19. The internal combustion engine of claim 11, wherein:
the camshaft includes a plurality of rotating surfaces; and
said rollerized camshaft support further includes a plurality of rollerized bearings and a plurality of bearing supports, one rollerized bearing an bearing support for each of said a plurality of rotating surfaces.

20. A method for rotatably supporting a camshaft for a Type I valvetrain, the camshaft for causing selective movement of each of the at least one intake valve and at least one exhaust valve of a reciprocating engine, wherein the camshaft has at least one rotating surface region, said method comprising the step(s) of:
providing at least one rollerized bearing support, wherein each of said rollerized bearing support includes:
a roller type bearing having an inner raceway, an outer raceway, and a plurality of rotating elements disposed there between and extending widthwise across the respective raceways,
a bearing support structure having a top support member and a bottom support member,
wherein the bearing bottom support member is configured so as to complement a configuration of the Type I valvetrain, and
wherein the bearing upper support member and bearing lower support member are configured so as to receive there between said at least one rollerized bearing so that the outer raceway opposes an inner surface for both the bearing upper support member and bearing lower support member; and
locating a respective one of the at least one roller bearing about each of the at least one rotating surface region of the camshaft and rotatably securing the camshaft and the respective roller bearing between the bearing upper support member and bearing lower support member.
